(19) United States
(12) Patent Application Publication
(10) Pub. No.: US 2018/0310497 A1
(43) Pub. Date: Nov. 1, 2018

(54) ROTATING HYDROPONIC GROWING SYSTEM

(71) Applicant: Jacob Andrew Farmer, Ashland, OR (US)

(72) Inventor: Jacob Andrew Farmer, Ashland, OR (US)

(21) Appl. No.: 15/965,113

(22) Filed: Apr. 27, 2018

Related U.S. Application Data
(60) Provisional application No. 62/491,584, filed on Apr. 28, 2017.

(51) Int. Cl. A01G 31/04; A01G 7/04; A01G 29/00

(52) U.S. Cl. CPC A01G 31/047; A01G 29/00; A01G 7/045

(57) ABSTRACT

The present invention relates generally to agriculture. A growing system may use a movable cylinder which rotates around a central axis to secure various plants, where the root structure of the plant or plants is substantially contained inside a movable cylinder, and where plants and roots are watered or provided nutrients via a fluid which may be sprayed inside a movable cylinder, and where plants may grow their plant mass, stems, or harvestable parts substantially outside of movable cylinder. The various embodiments and methods of the present invention may allow for large quantities of plants to be grown via hydroponic or aeroponic techniques while taking up minimal space and may be used indoors.

### CROSS REFERENCES TO RELATED APPLICATIONS

This application claims the benefit of U.S. Provisional Patent Application No. 62/491,584 filed Apr. 28, 2017, and incorporates the disclosure of that application by reference.

### BACKGROUND OF THE INVENTION

In the field of agriculture it is desirable to grow larger quantities of plants in a smaller amount of space, especially when indoors where space is more costly. With prior art techniques plants are often arranged in an array of potting or tray systems.

One method to achieve higher density of plants within a given amount of space is to arrange the plants around a circular apparatus or fixture. Prior art systems may arrange plants around a circular apparatus where the plants grow generally inward toward a central axis. A light source may be arranged along a central axis to provide even light to all the plants during rotation.

However, these prior art systems are limited in several ways. Because plants grow inward they are difficult to service, maintain, and harvest. As plants grow inward, space is increasingly limited which limits the growth potential of the plants as well as the species and size of plants the system can accommodate.

Additionally, the temperature and humidity near the root structure of some kinds of plants must be carefully maintained within tight parameters to achieve maximum harvest yield of the plants, fruits, vegetables, or flowers of the plants. Prior art systems may operate by dipping the root structure in a water solution as the plants are moved around the apparatus, but this may create problems in that the temperature and humidity near the roots is largely dictated by the environment of the growing room. It may be difficult or impossible to for example, maintain the roots at a different temperature than the rest of the room, when using prior art growing systems or techniques.

The present invention solves these problems and others. Having the plants grow generally outward away from a movable cylinder and away from a central axis, the plants continually move into a more open space as they grow. The plants are easy to access by a worker to service, maintain, and harvest. Because a movable cylinder of the present invention may be substantially enclosed, and the roots of the plants may be substantially enclosed within a movable cylinder, the temperature and humidity of the root environment can be more precisely monitored and controlled.

Additionally, a plurality of lights may be arranged around a movable cylinder of the present invention allowing more lights and a variety of different lights as needed for optimal growing of a given kind of plant. Because the movable cylinder of the present invention can be rotated, all plants are able to be exposed to the wavelengths of light produced by one or more different kinds of lights throughout the rotation. Most plants are not negatively affected by short intervals of light and shade as they move throughout the rotation, so this does not pose significant problems when growing many kinds of plants.

Another additional benefit of the present invention is that plants may be installed in a growing system of the present invention as cuttings or clones as they may be sometimes referred to, where the cuttings or clones may have no roots. Using prior art growing systems, a separate cloning machine may be required to sprout roots on a cloned plant, then the cloned plants may need to be removed and transplanted to a different growing location or medium to allow further growth or harvest. This may be stressful for some plants and requires additional labor. Using a growing system of the present invention, plants may be used from cutting or clone stage all the way through to harvest of final product without removing plants from a growing system of the present invention.

### SUMMARY OF THE INVENTION

The present invention relates generally to agriculture. More specifically, the present invention is a growing system which uses a movable cylinder to support and water various plants via hydroponic and aeroponic means that can be used indoors to grow large amounts of plants in a small space.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1 representatively illustrates a perspective view of a growing system of an exemplary embodiment of the present invention;

FIG. 2 representatively illustrates a perspective view of a movable portion (which may comprise a movable cylinder) and a base portion of an exemplary embodiment of the present invention;

FIG. 3 representatively illustrates a perspective view of a base portion of an exemplary embodiment of the present invention;

FIG. 4 representatively illustrates a perspective view of a movable cylinder with side guards installed of an exemplary embodiment of the present invention;

FIG. 5 representatively illustrates a side view of a movable cylinder of an exemplary embodiment of the present invention;

FIG. 6 representatively illustrates a perspective view of a movable cylinder of an exemplary embodiment of the present invention;

FIG. 7 representatively illustrates a front view of a movable cylinder of an exemplary embodiment of the present invention;

FIG. 8 representatively illustrates a side view of a movable cylinder of an exemplary embodiment of the present invention;

FIG. 9 representatively illustrates a perspective view of a rotational connection of a movable cylinder of an exemplary embodiment of the present invention;

FIG. 10 representatively illustrates a perspective view of a mesh basket of an exemplary embodiment of the present invention;

FIG. 11 representatively illustrates a perspective view of a segment assembly of a movable cylinder of an exemplary embodiment of the present invention;

FIG. 12 representatively illustrates a side view of a segment assembly of a movable cylinder of an exemplary embodiment of the present invention;

FIG. 13 representatively illustrates a sectional side view of a movable cylinder assembled with plants and watering mechanism of an exemplary embodiment of the present invention;

FIG. 14 representatively illustrates a section view of a plant with a medium positioned within an opening of a movable cylinder of an exemplary embodiment of the present invention;

FIG. 15 representatively illustrates a partial section view of the front of a growing system including functional diagram of fluid flow of an exemplary embodiment of the present invention;

FIG. 16 representatively illustrates a partial section view of a plurality of a growing system plumed together of an exemplary embodiment of the present invention;

FIG. 17 representatively illustrates a side view of a movable cylinder with a drive motor, pulley, and belt system of an exemplary embodiment of the present invention;

FIG. 18 representatively illustrates a section view of an alternate embodiment of the present invention.

Elements and steps in the figures may be illustrated for simplicity and clarity and have not necessarily been rendered according to any particular sequence. For example, steps that may be performed concurrently or in different order may be illustrated in the figures to hep improve understanding of embodiments of the present invention.

### DETAILED DESCRIPTION OF EXEMPLARY EMBODIMENTS

Turning now to the drawings, several exemplary embodiments of the present invention are considered. One skilled in the art of plastic enclosure fabrication, basic mechanical knowledge, plumbing, and agriculture will be able to understand and create the various embodiments of the present invention. Though an embodiment of the present invention is suggested, it will be clear that other embodiments are possible without deviating from the spirit of the present invention.

The parts may be constructed from various materials as known to one skilled in the art. The materials may include but are not limited to various plastics, metals, composites, or wood. Best mode of manufacture may be to fabricate or machine parts from polypropylene sheeting which is commercially available. Polypropylene is easy to work with and machine into various shapes, resists chemicals, and is environmentally friendly. The various parts may be welded together using various means including ultrasonic welding, or the use of a heat gun and plastic welding rod, among other possible methods including but not limited to various kinds of glue, epoxy, or other appropriate adhesive.

Various fasteners such as screws, bolts, washers, nuts, or bushings may be used where appropriate. Various plumbing, piping, or fittings may also be used where appropriate.

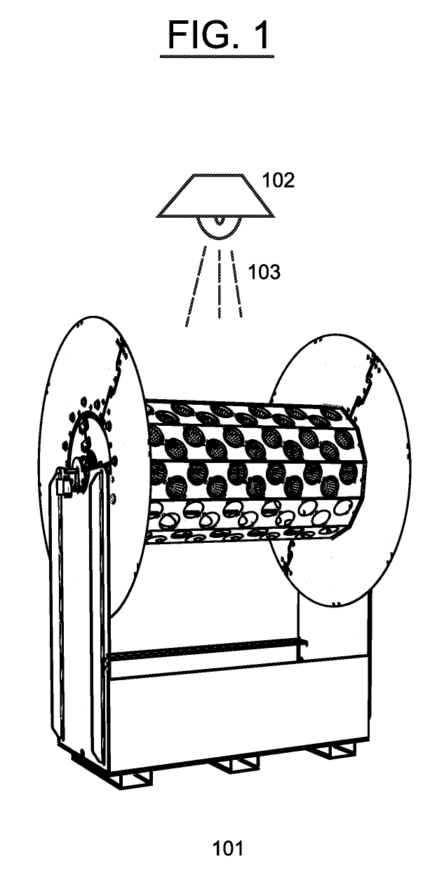

FIG. 1 may illustrate a perspective view of a growing system 101 of an exemplary embodiment of the present invention. When in operation, at least one of a light source 102 may be used to direct at least one of a wavelength of light 103 substantially toward at least one part of a growing system 101. Multiple light sources 102 may be used and may be oriented or arranged around a growing system 101 as appropriate for the given kind of plant being grown using the growing system. One skilled in the art would be able to install a light 102 to a supporting structure (not illustrated) to suspend or otherwise mount a light 102; for example, a light 102 may be mounted to a ceiling above a growing system 101, or mounted to a supporting or scaffold structure or tent located near or around a growing system 101.

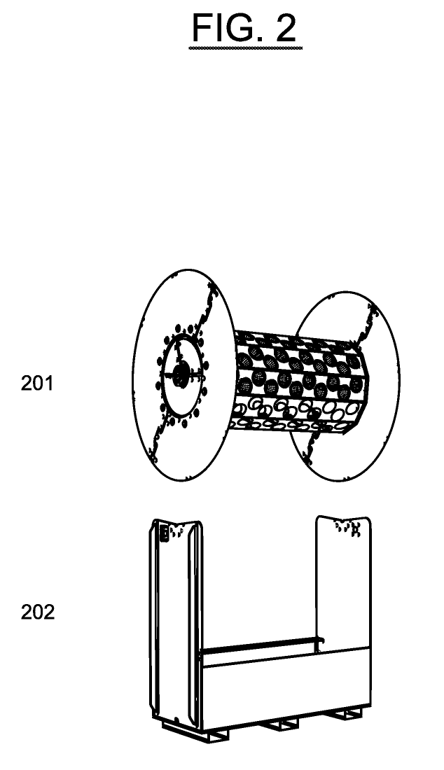

FIG. 2 may illustrate a movable portion 201 and a base portion 202 of a growing system 101.

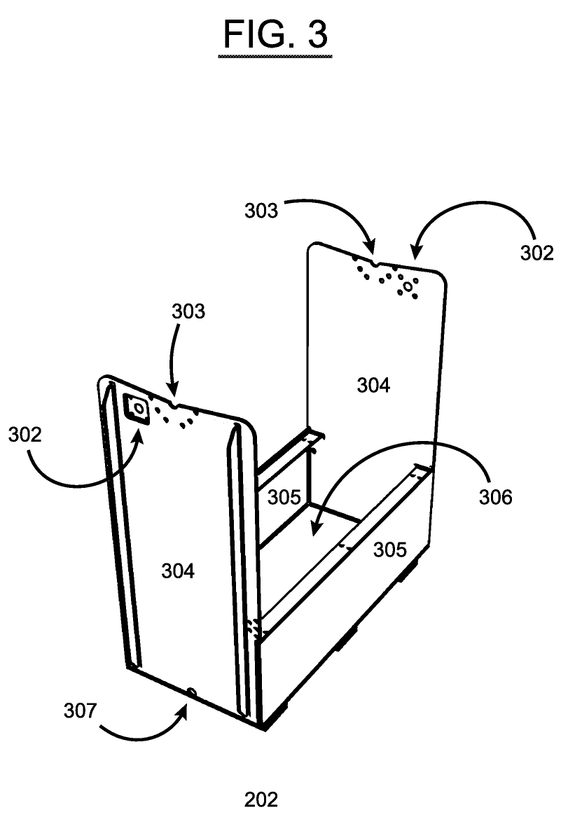

FIG. 3 may illustrate a base portion 202 of a growing system 101. A base portion 202 may comprise side portions 304 and front and back portions 305. A material may provide a floor portion 306 to a base portion 202. These parts may form an enclosure which may be generally open on the top and may be water tight around the sides and bottom, and may be used to contain a reservoir of a fluid 1502. There may be various holes machined into a base portion 202 such as one or more of an opening 307 which can be attached to with plumbing for circulating a fluid, draining a fluid, monitoring a fluid, mixing a fluid or so on. Side portions 304 may include mounting holes 302 or pockets to attach a motor 1702. The upper edge of side portions 304 may include mounting detents 303 and screw holes to receive a central axis 406 of a movable portion 201 or movable cylinder 402.

Stand off material made be added on the bottom side of a floor portion 306 to allow moving of the growing system 101 by fork lift, pallet jack, or other device.

It is suggested to leave the upper edge of side portions 204 open to allow receiving of a movable portion 201 or movable cylinder 402 from the top. This may allow a worker or lifting mechanism or machine or automated machine to easily and efficiently remove, install, exchange, or replace a movable portion 201 or movable cylinder 402 from the top without moving, draining fluid, or otherwise disturbing a base portion 202. It may be desirable to for example, remove a movable portion 201 or a movable cylinder 402 when plants are ready to harvest, and replace it with a different movable portion 201 or a movable cylinder 402 which may contain no plants or may have freshly installed clones such that substantially uninterrupted operation of a growing system of the present invention may continue with minimal down time.

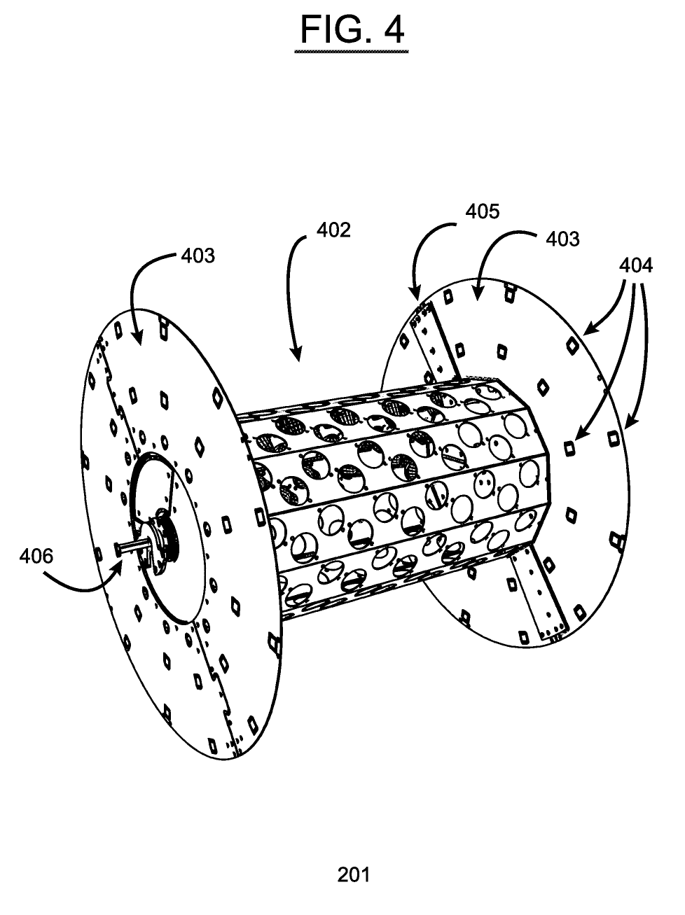

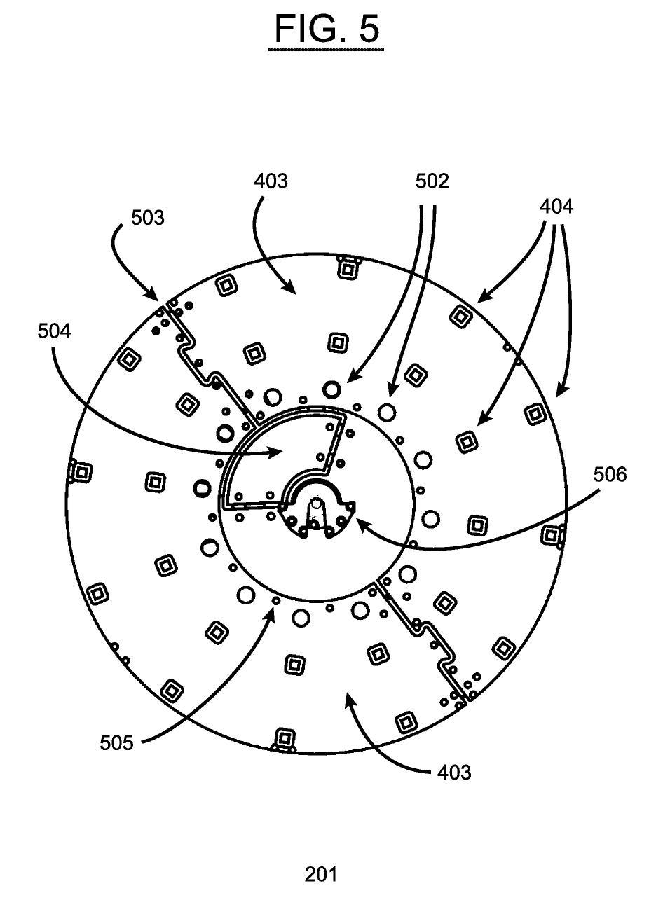

FIG. 4 and FIG. 5 may illustrate a movable portion 201. A movable portion 201 may comprise a movable cylinder 402, and may optionally have fitted one or more of a side guard 403 installed. A side guard 403 may provide various useful features to a growing system of the present invention as described herein. A side guard 403 may keep separated fluid draining from inside a movable cylinder 402 and the plant mass or leaves of one or more plants growing in the system. A fluid may be allowed to drain from inside a movable cylinder 402 to the outer surface of a side guard 403 via one or more of a hole 502 arranged on a side guard 403. One or more drain extension pieces 702 may assist in the transfer or drainage of a fluid to the outer surface of a side guard 403. A side guard 403 may provide various attachment points 404 for a net, screen, braces, scaffolding, rods, spokes, or other structure to support the stem, leaf, and plant mass of plants growing in the system. A side guard 403 may be split 503 into two or more parts that join together. This may make the installation and removal of a side guard 403 easier. One or more of a portion of a side guard 403 may be attached together with a joining component 405. Bolts may be inserted through holes 505 to attach a side guard 403 to a movable cylinder 402. A removable cover 504 may be installed over or within an opening 606. A hold down component 506 may be installed over top of a central axis 406 and connected to mounting holes 303 to secure a movable portion 201 or a movable cylinder 402 to a base portion 202.

It is considered by the present invention that a side guard may instead be embodied as one or more spokes extending outward in relation to a central axis 406. Spokes may provide some or all of the benefits and attachment points as a side guard 403 as described herein.

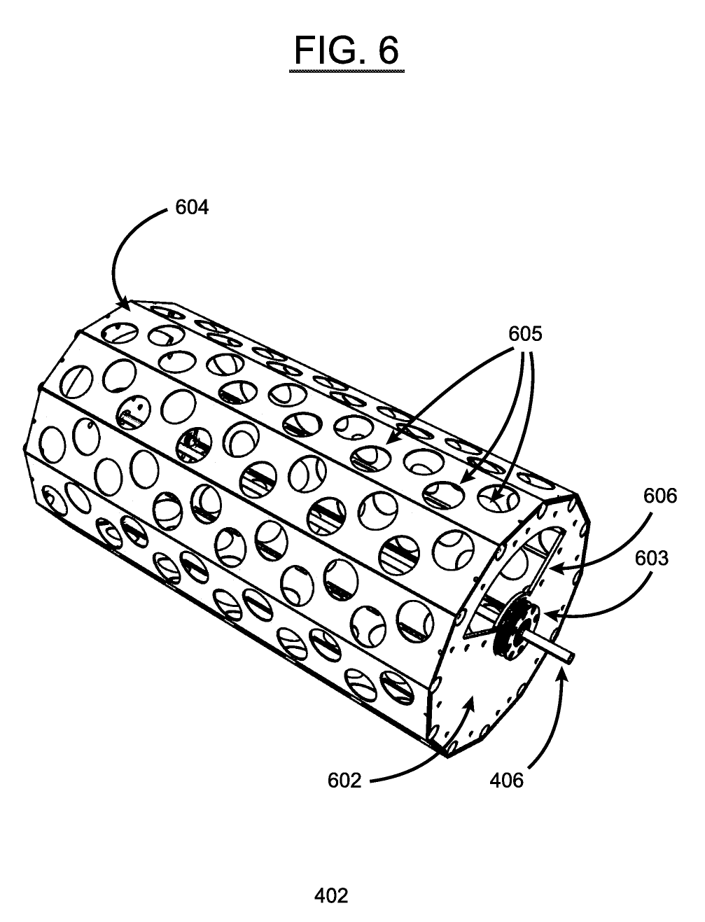

FIG. 6 illustrates an exemplary embodiment of a movable cylinder 402. The outer surface 1315 or inner surface 1314 or both of a movable cylinder may be perfectly round or substantially round. In such case a movable cylinder may be constructed from or similar to a barrel or large diameter pipe or the like. However, a movable cylinder 402 may not necessarily be perfectly round, or may not be round at all. Instead a series of a plurality of facet pieces 604 may be arranged around an axis or a central axis 406, and facet pieces 604 may be connected or welded together so as to form a substantially water tight connection. If facet pieces 604 are substantially flat as in an exemplary embodiment of the present invention, the facet pieces may achieve a better seal with a mesh pot 1002 or a membrane 1402. A plurality of openings 605 may be arranged in various locations of the outer surface of a movable cylinder, and may be arranged in various locations along one or more of facet pieces 604. It is considered that various possible embodiments of the present invention may not comprise a cylinder that is round at all, but rather, may be square, spherical, or other shape which may operate in a similar way as the various exemplary embodiments described herein.

In one exemplary embodiment of the present invention, twelve openings 605 may be arranged along a given facet piece 604, and there may be twelve facet pieces 604 that comprise all or part of a movable cylinder 402. In such an embodiment, it may be possible to grow one hundred forty four individual plants, or one large plant having a common root structure substantially within a movable cylinder 402 having one hundred forty four stems, or any combination there of.

Though various illustrations of various embodiments of the present invention may be drawn with only one or only a few holes 605 populated with plants or mesh baskets 1002 for simplicity, it is considered that under normal operation all holes 605 of a given growing system will normally be populated. Holes 605 that are not populated may be fitted with various examples of a cover, blank, or sealing material so as to substantially close off any not populated holes 605 so a movable cylinder remains substantially water tight along the surface of a movable cylinder.

In one exemplary embodiment of the present invention, the outer surface of a cylinder, which may be comprised of several facet pieces 604, may be structurally mounted to a central axis 406 with a material, such as a cylinder end cap 602, which may be fabricated from a plastic or other appropriate material. A cylinder end cap 602 may be affixed to each end of a movable cylinder 402, and may provide one or more of an access opening 606 whereby a worker can inspect, clean, or otherwise access the interior surface of a movable cylinder 402, or the root structure of plants growing in the system. A cylinder end cap 602 may also provide an attachment location for a cylinder drive mechanism 603.

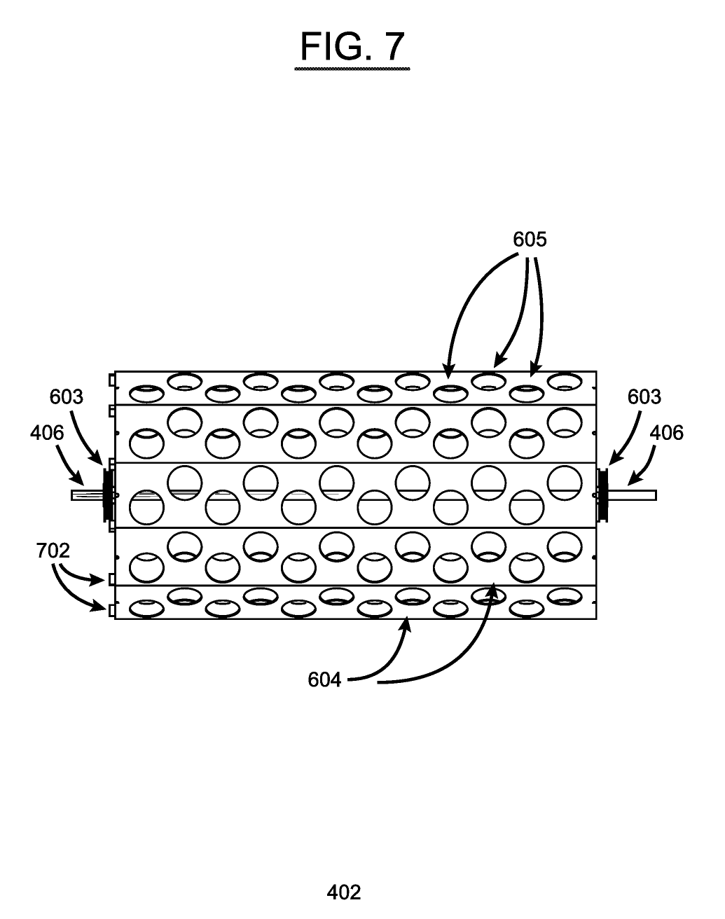

FIG. 7 illustrates a front view of an exemplary embodiment of a movable cylinder 402. A central axis 406 may extend through substantially the center of a movable cylinder 402 and protrude from each end, and may partially or fully engage with or otherwise provide support for a cylinder drive mechanism 603, which may be present on one end or both ends of a movable cylinder 402. As a movable cylinder 402 is rotated about a central axis 406, in one exemplary embodiment, holes 605, facet pieces 604, end caps 602, and cylinder drive mechanisms 603 may rotate in a circular direction, while a central axis 406 may be substantially stationary and not rotating. The rotation may operate around a rotational connection 803 which may be a ball bearing, and wherein a ball bearing may support the weight and mass of the described rotating parts, and wherein a ball bearing may be supported by a central axis 406, and wherein a central axis 406 may be supported by a base portion 202 or another structure, scaffold, or apparatus.

Drain openings 802 may have fitted within drain openings 802 drain extension pieces 702, which may provide a path for moisture drainage out of drain openings 802 and to the outer surface of a side guard 403 via holes 502 in a side guard 403, and wherein drain extension pieces 702 may extend through holes 502 in a side guard 403.

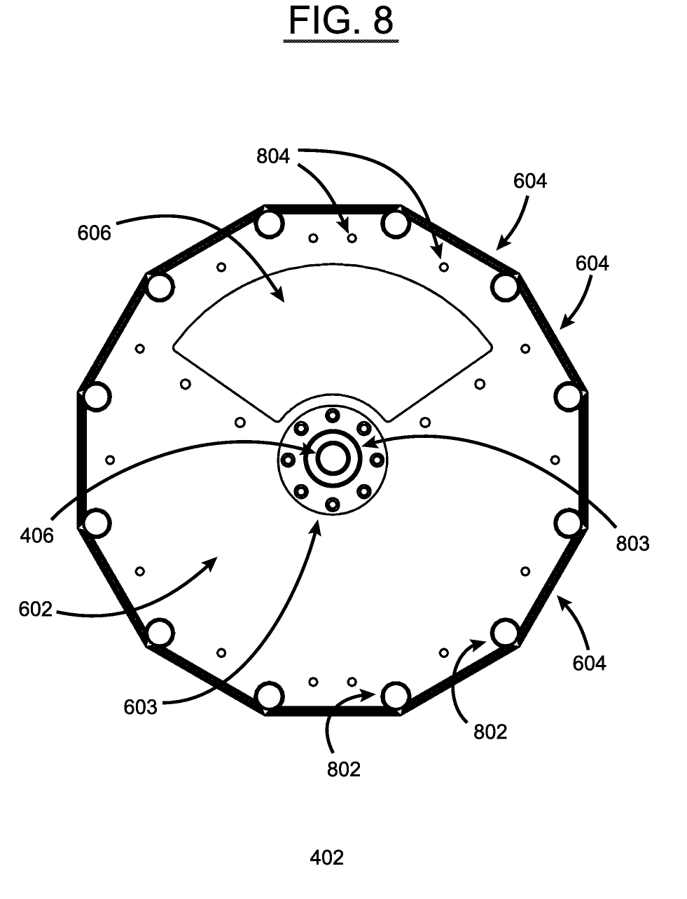

FIG. 8 illustrates a side view of an exemplary embodiment of a movable cylinder 402. A plurality of facet pieces 604 may be affixed around the outer profile of a cylinder end cap 602. The profile may not be perfectly cylindrical but rather may fit the shape created by the plurality of facet pieces 604. Cylinder end cap 602 may be welded or otherwise fastened to the plurality of facet pieces 604 so as to achieve a substantially water tight seal between the pieces. A movable cylinder 402 may rotate around a central axis 406 using a rotational connection 803. A movable cylinder 402, which may include a plurality of openings 605 may be structurally mounted to a central axis 406 via one or more of a cylinder end cap 602, or via a cylinder drive mechanism 603, or via a rotational connection 803, or via any combination or quantity thereof. When assembled with a rotational connection 803, a movable cylinder may be able to rotate substantially concentric to a central axis 402, and thus any openings 605, which may contain one or more of a plant 1302 may also rotate substantially concentric to a central axis 402.

One or more holes 804 may be arranged on cylinder end cap 602 to provide a mounting location for one or more of a side guard 403 or other support mechanism, scaffolding, spokes, mounting bracket, or the like which may facilitate the physical support or guiding of plants growing in the system, lighting or monitoring equipment or the like.

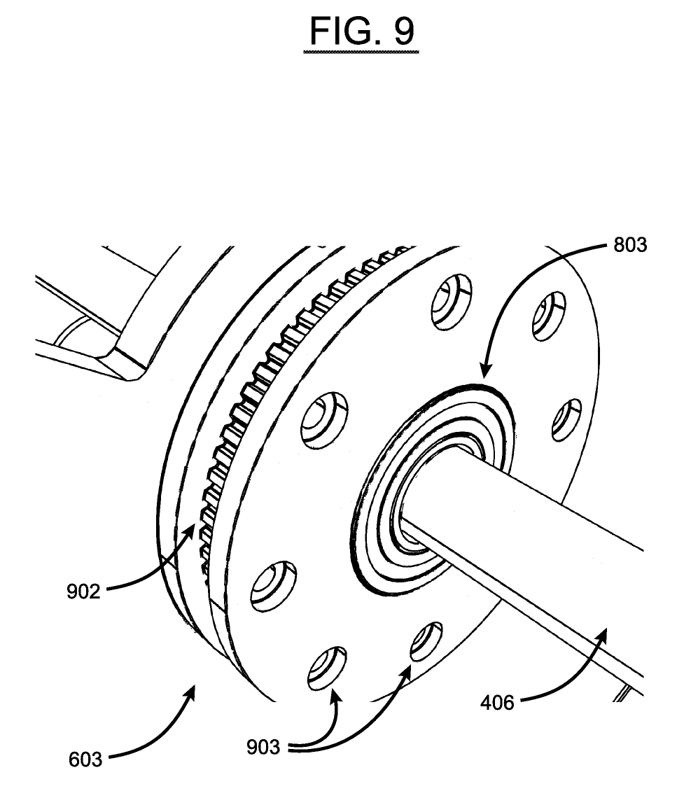

FIG. 9 illustrates a more detailed perspective view of an exemplary embodiment of a cylinder drive mechanism 603. A cylinder drive mechanism may be constructed from a single piece of material or several pieces of material fit together, and may comprise a belt track 902, which may allow a drive belt 1704, chain, or other appropriate drive source to impart rotational movement to a movable cylinder 402. A belt track 902 may be smooth or may include various teeth or detents to facilitate mating with a drive belt 1704. A rotational connection 803 may be arranged between a central axis 406 and a cylinder drive mechanism 603, or a cylinder end cap 602, or any combination thereof. A rotational connection 803 may be a ball bearing assembly, a bushing material, or other appropriate material as would be known to one skilled in the art. A rotational connection 803 may allow a movable cylinder 402 to move or rotate around a central axis 406 with minimal friction. A cylinder drive mechanism 603 may connect to a cylinder end cap 602 with bolts via one or more bolt holes 903. A rotational connection 803 may be partially or fully enclosed within a cylinder drive mechanism 603.

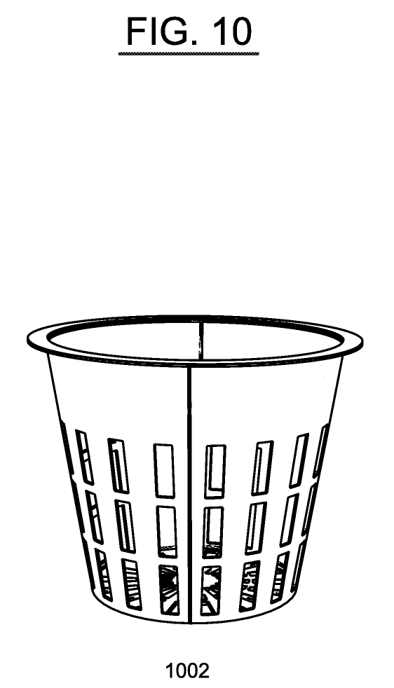

FIG. 10 illustrates a perspective view of an exemplary mesh basket 1002.

Mesh baskets may have a diameter of approximately three inches, though larger or smaller mesh baskets may be used depending on the size of the plants to be grown using the system. Mesh baskets are commercially available and commonly known and used to those skilled in the art of hydroponics and other methods of plant growing. It is considered that any kind of basket, pot, mounting, fixture, or apparatus which may be more appropriate to a given kind of plant may be used in place of a mesh basket 1002.

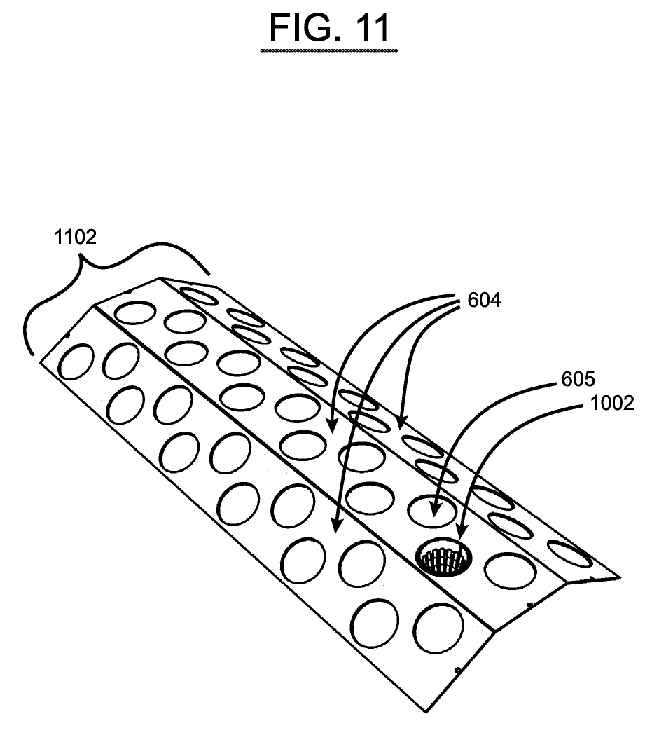

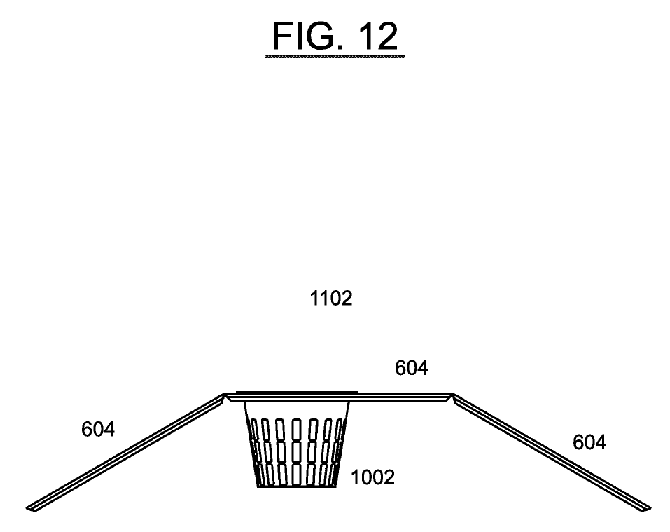

FIG. 11 and FIG. 12 illustrates a segment assembly 1102 of a movable cylinder 402 of an exemplary embodiment of the present invention. A segment assembly 1102 may be comprised of a plurality of facet pieces 604. It is considered that several facet pieces may be machined from a single sheet of material and wherein the facet pieces remain partially or fully connected to each other, or a score line is placed between them. This may make it easier to assemble a plurality of segment assembly pieces 1102 when constructing the system, and may provide easier transport of the required pieces prior to final assembly of a movable cylinder which may be performed at a different location. One or more of a mesh basket 1002 may fit within openings 605 of a segment assembly piece 1102 or of one or more of a facet pieces 604.

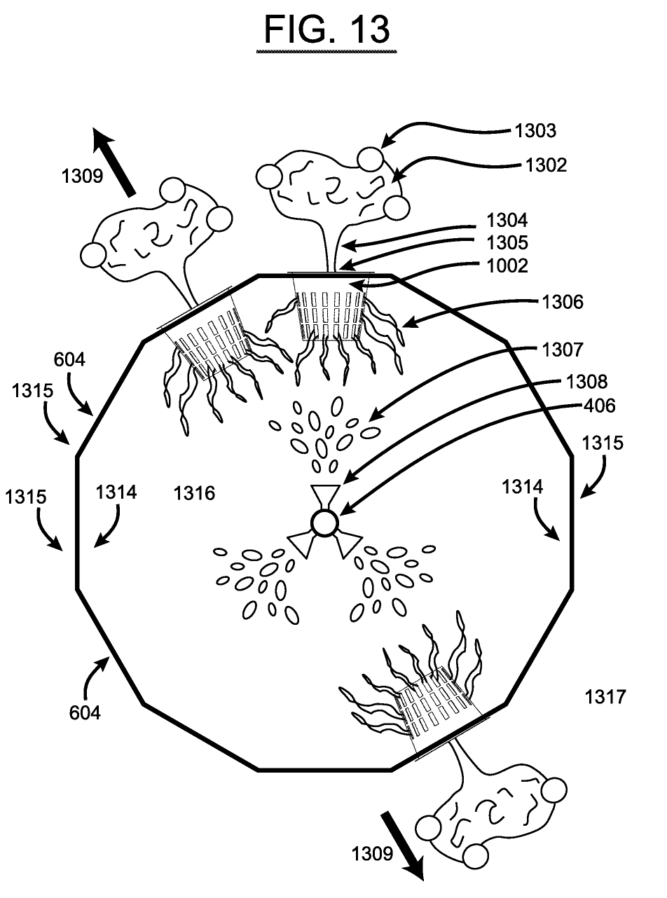

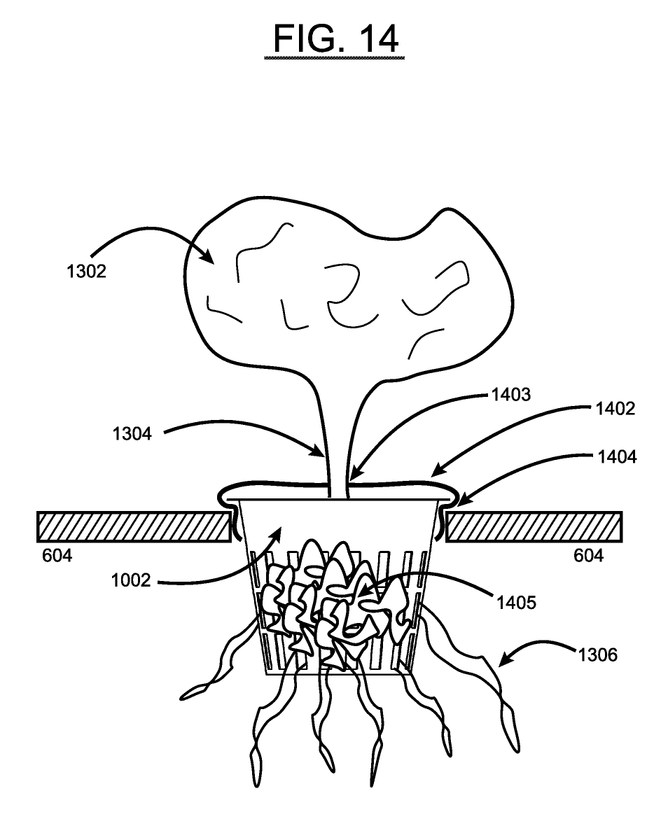

FIG. 13 illustrates a sectional side view of a movable cylinder 402 assembled with plants and watering mechanism of an exemplary embodiment of the present invention. FIG. 14 illustrates a section view of a plant 1302 with a medium 1405 at least partially enclosed within a mesh basket 1002, and positioned within an opening 605 of a facet piece 604 of a movable cylinder 402 of an exemplary embodiment of the present invention.

A movable cylinder 402 may have an interior space 1316 that is substantially enclosed within a movable cylinder 402 by one or more of a segment assembly 1102, facet pieces 604, cylinder end cap 602, cylinder drive mechanism 603, or another material, assembly, or apparatus, or any combination thereof, which when assembled, may be substantially water tight except for various openings for connections, screws, bolts, a central axis 406, cylinder drive mechanism 603, drain openings 802, and the like. In a similar way a movable cylinder 402 may be substantially water tight when all holes 605 are populated with a various embodiment of a plant, mesh pot, a membrane, or other item or apparatus or cover or plug that, when present, causes a movable cylinder 402 to become substantially water tight. A movable cylinder may have an inner surface 1314 that forms a boundary that is substantially within 1316 a movable cylinder, and a movable cylinder may have an outer surface 1315 that forms a boundary that is substantially outside 1317 the interior 1316 of a movable cylinder 402.

General operation of an exemplary embodiment of the present invention may be described as follows. One or more of a facet piece 604, or the outer surface of a movable cylinder 402 may comprise a plurality of openings 605 and may be capable to receive via openings 605 one or more of plants 1302, which may be the same kind of plants or may be different kinds of plants, such that plants extend through at least one of a plurality of openings 605, and wherein at least one plant 1302 is oriented such that the plant mass of a plant generally grows in a direction 1309 away from a central axis 406, and wherein the roots 1306 of a plant 1302 grow substantially toward a central axis 406.

This arrangement may also be described in accordance with one exemplary embodiment of the present invention as follows. One or more of a facet piece 604, or the outer surface of a movable cylinder 402 may comprise a plurality of openings 605 and may be capable to receive via openings 605 one or more of a plant 1302, which may be the same kind of plants or may be different kinds of plants, such that the one or more of a plants extend through at least one of a plurality of openings 605, and wherein at lease one of a plurality of openings 605 is capable of receiving at least one plant 1302, arranged such that a root structure of a plant is contained substantially within a movable cylinder 402 and wherein the plant mass of a plant substantially grows outside the interior of a movable cylinder 402, and wherein a plant mass may comprise a stem 1304, various foliage, leaves, vegetation or harvestable part 1303 of a plant, or any combination thereof.

A plant may be any kind of plant, and may optionally comprise one or more of a fruit, vegetable, flower, nut, or other harvestable part 1303 of a plant. A plant 1302 may comprise a stem 1304. Said stem 1304 may protrude through an opening 605, and may protrude through a membrane 1402. The root structure 1306 of a plant 1303 may connect via a stem 1304. The root structure 1306 of a plant may grow through and entangle with a medium 1405. A medium 1405 may be any of a variety of commercially available or custom fabricated structure appropriate to the kind of plant being grown using the growing system. A medium 1405 may be a loose foam mesh structure that allows a fluid to reach the root structure 1306 and also allows a fluid to drain away from a root structure 1306. An appropriate medium may be that which provides a good balance between physical structure for the a root structure 1306 to grab or secure onto, and yet still provides as much open space as possible for root growth and the exchange of a fluid to and from a root structure 1306. Other possible medium 1405 options may include commercially available products such as Rockwell, commonly used in agriculture, or other products such as aquarium filter media, peat moss, soil, paper, various shapes of stone, rock, plastic, wood, various kinds of shavings, or other growing medium. A medium 1405 may also comprise air, water, vapor, or any combination thereof which may be beneficial to certain kinds of plants grown using the system.

A membrane 1402 may be arranged between a medium 1405 containing basket 1002 and a plant 1302 or the stem 1304 or other part of a plant so that a substantially water tight seal 1403 is achieved between said medium 1405 containing basket 1002 and said plant 1302 or stem 1304 or other part of a plant. This seal may prevent moisture or liquid from inside a movable cylinder 402 from escaping or draining down the stem 1304 of a plant 1302.

A membrane 1402 may also be arranged such that a membrane 1402 creates a substantially water tight seal 1404 between a medium 1405 containing basket 1002 and an opening 605 of a movable cylinder 402.

One example of a membrane may be a common latex balloon. One method of assembly may comprise the steps of filling a mesh basket 1002 with a medium 1405, then stretching a balloon around a mesh basket 1002, then poking the stem 1304 of a non-rooted plant through the balloon, which may be a membrane 1402. Other customized membranes may be fabricated from various materials and of various sizes as appropriate.

Continuing with FIG. 13, a central axis 406 may allow a fluid to flow along a central axis 406, either internal to a central axis or via a secondary pipe, hose, or conduit arranged along at least part of a length of a central axis 406. A central axis may be a pipe itself and may be constructed from common plumbing pipe material or conduit material as would be commercially available and known to one skilled in the art of plumbing.

A fluid may be allowed to flow inside a central axis 406, wherein a central axis 406 may be a tube. A fluid 1307 may be directed from a central axis or from a secondary conduit at least partially along a central axis, wherein a fluid 1307 may be directed substantially toward the root structure 1306 of at least one of a plant 1302. A fluid 1307 may be disbursed via one or more of a nozzle 1308. Various commercially available nozzles may be used. One or more of a nozzle 1308 may be distributed along a central axis, and may draw a fluid 1307 from the central axis. Depending on the kind of plants being grown in a growing system of the present invention, it may be desirable to use high flow rate directional nozzles, or it may be more beneficial to use atomizing mister nozzles that generate a fog of vapor, which may be used to elevate or control the humidity level within a movable cylinder 402.

A method of growing at least one of a plant may be possible using one or more of an exemplary embodiment of the present invention. A method for growing a plant may comprise the steps of: locating at least one part of at least one plant 1302 within at least one of a plurality of openings 305 located on a movable cylinder 402; orienting said at least one plant 1302 such that a root structure 1306 of the at least one plant 1302 is contained substantially within 1316 a movable cylinder 402 and wherein the plant mass 1304, 1303, of the at least one plant 1302 substantially grows outside 1317 the interior 1316 of a movable cylinder 402.

A method of growing at least one of a plant may also comprise the steps of: allowing a fluid 1307 to flow substantially to the interior 1316 of a movable cylinder 402, and wherein a root structure 1306 of at least one plant is provided at least one of a nutrient which may be comprised within said a fluid 1307. The fluid 1307 may be pumped or gravity drained, it may flow down a central axis 406 and may be disbursed via one or more of a nozzle 1308. It is considered also that a fluid 1307 or a gas may be sprayed or otherwise directed substantially into the interior 1316 of a movable cylinder 402 from outside 1317 a movable cylinder 402 through an opening 606, drain holes 802, one or more of a holes 605, or via another opening in a movable cylinder.

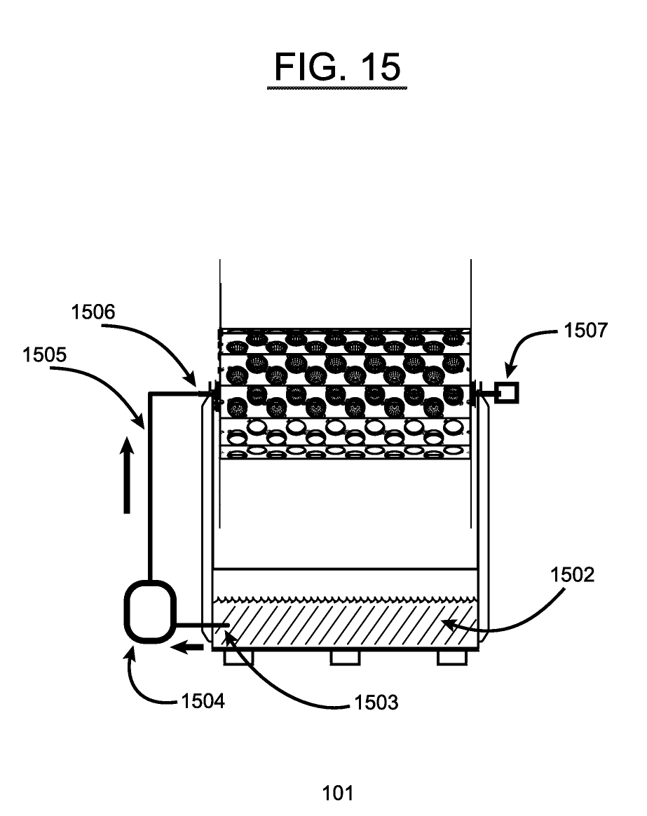

FIG. 15 illustrates a partial section view of the front of a growing system including functional diagram of fluid flow of an exemplary embodiment of the present invention. In one example, a fluid 1502 (which may be the same fluid as a fluid 1307) may be collected in a reservoir comprised within a base portion 202 of a growing system 101 of the present invention. A plumbing connection 1503, which may connect to a hole 307 of a base portion 202, may draw a fluid 1502 out of said reservoir via a pump 1504. A pump 1504 may force a fluid 1502 through a second plumbing connection 1505 to one side of a central axis 402. A plumbing connection 1505 may be a flexible connection such as a flexible hose, and may include at least one of a removable connection or fitting so as to allow easy disconnection of at least one end of a plumbing connection 1505.

A pump 1504 may be a common electrically driven pump or may be other means of pumping including pneumatic, hydraulic, or gravity driven pumps, or human powered pumps such as hand pumps or crank pumps. There may be a connection 1506 between a plumbing connection 1505 and a central axis 402, wherein a connection 1506 may be detachable. A fluid 1502 may be forced through a central axis 402 under pressure from a pump 1504 where it may be disbursed as fluid 1307 via one or more of a nozzle 1308 which may be inside a movable cylinder 402. A pipe cap 1507 may be installed on the opposite end of a central axis 402 to prevent spillage and maintain pressure within a central axis 402. As a fluid 1502 or a fluid 1307 accumulates inside a movable cylinder 402 it may be allowed to drain out of a movable cylinder 402 via one or more holes 802, and may also flow through drain extension pieces 702, and holes 502. The drainage may occur naturally via gravity. A fluid may flow along the outer surface of a side guard 403 where some or all of a fluid may eventually drip via gravity back into a reservoir of a base portion 202 of a growing system 101 of the present invention.

In this way, a given quantity of a fluid 1502 may be substantially continually circulated from a reservoir into a movable cylinder 402 and back into a reservoir for re-use.

A fluid 1502 which may also be the same as fluid 1307 may be a water solution and may contain various chemicals or nutrients or any combination thereof, wherein said water, chemicals, or nutrients may assist the growing, feeding, watering and overall well being of one or more of a plant 1302. Various supporting components may also be installed or used within or in association with various components of a growing system. For example, various filtration units may be installed to clean, purify, aerate, or treat a water source before being introduced into a growing system of the present invention as a liquid 1502. Various float valve devices as would be known to one skilled in the art may be used to continually top off or otherwise maintain the level of a fluid 1502 at a desired level. Additionally, various measurement devices may sample various water quality parameters of a fluid 1502 and may be computer controlled to dose or otherwise add various chemicals or nutrients or both to a fluid 1502.

A computer may control any or all of the parameters of a growing system of the present invention. For example, a computer may monitor various water levels, parameters, flow rates and the like and adjust these automatically as needed depending on the environment, the kind of plant, and the stage of plant growth. A computer may also control the rotational speed of a movable cylinder 402, or any lighting associated with a growing system, or the watering frequency or intensity of watering by controlling a pump 1504.

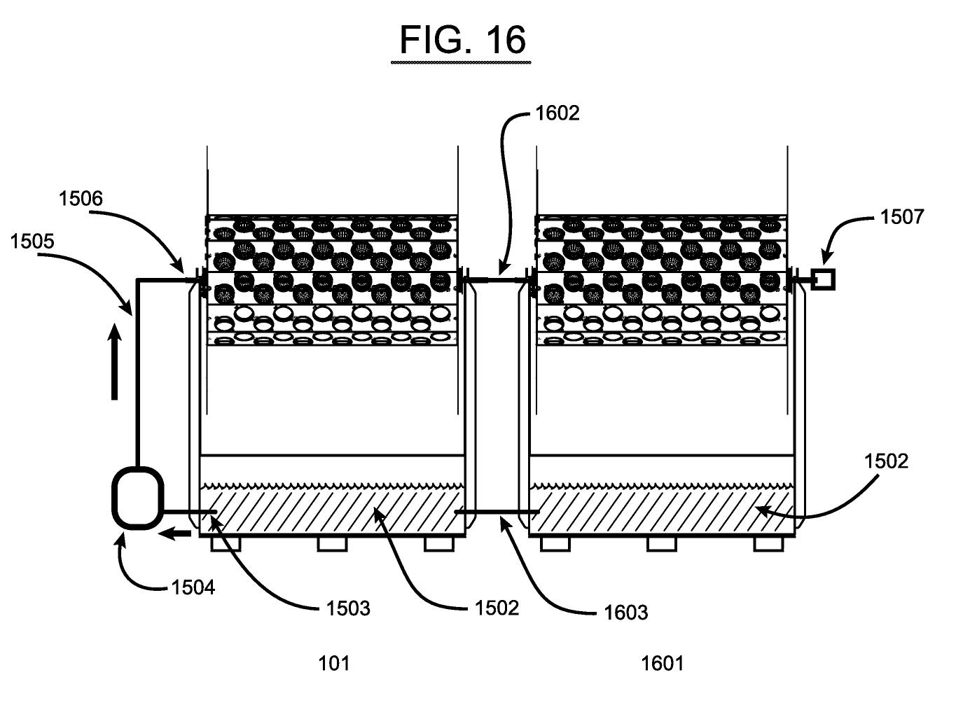

FIG. 16 illustrates a partial section view of a plurality of a growing system plumed together of an exemplary embodiment of the present invention. It is considered in an exemplary embodiment the present invention that a plurality of a growing system 101 of the present invention may be plumbed together such that a single pump 1504 may supply a liquid 1502 to a plurality of a growing system 101. In such an embodiment, a central axis 406 of a first movable cylinder 402 of a first growing system 101 may be connected to a central axis 406 of a second movable cylinder 402 of a second growing system 1601 via a plumbing connection 1602, which may be ridged or flexible. In a similar way, a reservoir of a first base portion 202 of a first growing system 101 may be connected to a reservoir of a second base portion 202 of a second growing system 1601 via plumbing connection 1603, which may be ridged or flexible, and wherein said plumbing connection 1603 may attach via a hole 307 or other hole specifically intended for this purpose.

Having a plurality of a growing system connected and sharing substantially the same fluid 1502 may simplify the process of maintaining various water quality parameters of a fluid 1502, and may make said water quality parameters more stable due to the larger volume of a fluid 1502. It is also considered that yet another reservoir (not illustrated) may be plumed together with one or more of a growing system of the present invention in a similar way which may further increase the volume of a fluid 1502 with similar beneficial results.

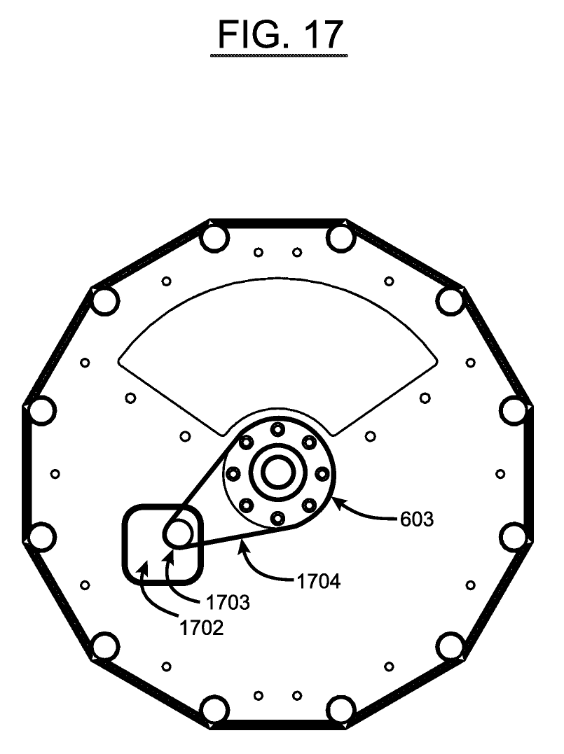

FIG. 17 illustrates a side view of a movable cylinder with a drive motor, pulley, and belt system of an exemplary embodiment of the present invention. A means of providing rotational movement to a movable cylinder 402 of one exemplary embodiment of the present invention may be described as follows. A motor 1702 such as an electric motor or geared electric motor may have fitted to the output shaft of a motor 1702 a pulley 1703, and a motor 1702 may be mounted to a base portion 202 via mounting holes 302 or at another location. A pulley 1703 may receive or otherwise engage with a drive belt 1704, and wherein a drive belt 1704 may also engage with a cylinder drive mechanism 603 or a belt track 902. When a motor 1702 is rotated, such an arrangement may cause a movable cylinder 402 to rotate, as well as, one or more of holes 605, one or more mesh baskets 1002, one or more of a medium 1405, one or more of a root structure 1306 of a plant 1302, one or more of a plant 1302, one or more of a harvestable part 1303 of a plant, or any combination thereof substantially concentrically around a central axis 406.

### ADDITIONAL EXEMPLARY EMBODIMENTS

It is considered by the present invention that various improvements and alternative embodiments of the present invention may be useful as follows.

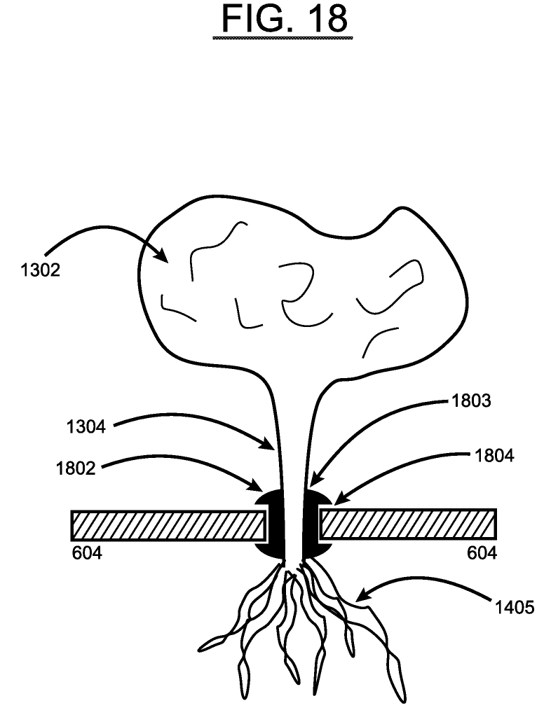

FIG. 18 may illustrate an alternative method for mounting a plant 1302 in a movable cylinder 402 of the present invention. A hole 605 may be made smaller and may seal against a stem 1304 of a plant directly or via a sealing component 1802 such as for example a rubber or foam grommet that may be commercially available. A sealing component 1802 may form a seal 1803 against the stem 1304 of a plant 1302 and may also form a seal 1804 against a hole or against a portion of a facet 604 of a movable cylinder 402, or in any combination there of.

In yet another exemplary embodiment of the present invention, it is considered that a mesh pot 1002 or medium 1405 containing mesh pot, or root structure 1306 of a plant, or in any combination thereof may be located substantially outside an outer surface of a movable cylinder 402, either substantially open to the environment or substantially enclosed within another enclosure (not illustrated), and wherein one or more of a hole 605 may be smaller, and may attach either directly or via a fitting, pipe, or tube to the described embodiment of a mesh pot 1002 or medium 1405 containing mesh pot, or root structure 1306 of a plant, or in any combination thereof may be located substantially outside an outer surface of a movable cylinder 402, and whereby a fluid, water, nutrients or any combination thereof may be exchanged with the root structure 1306 of a plant 1302 via one or more of a hole 605. This embodiment may be desirable in that it may reduce the diameter of a movable cylinder 402 and may be more appropriate for the growing of certain kinds of plants.

In yet another exemplary embodiment of the present invention, it is considered that the side and outer surface of a movable cylinder 402 may be substantially perforated or porous or otherwise substantially not water tight. This may allow a fluid 1307 to flow not only onto the root structure 1306 of a plant, but also the stem 1304, plant 1302 or harvestable item 1303 of a plant. This may be beneficial to certain kinds of plants where the entire plant may benefit from regular exposure to a fluid 1307 or 1502.

In yet another exemplary embodiment of the present invention, it is considered that an additional material may be placed over a membrane 1402 on the outer surface of a movable cylinder 402, and wherein may be affixed to the outer surface of a movable cylinder 402 or one or more of a facet piece 604. In said embodiment the additional material may prevent light substantially from reaching a membrane 1402 which may prolong the life of said membrane 1402. In said embodiment if the additional material is ridged, the additional material may provide additional support for a membrane or a mesh basket 1002 or both, and may assist in holding a mesh basket 1002 against a movable cylinder 402 or facet piece 604 such that a seal 1404 is more reliably maintained. It is considered that multiple additional materials may be stacked or layered in a similar way to as to provide substantially the same benefit or other additional benefit to the operation of a growing system of the present invention.

It is considered that a membrane 1402 may be constructed from a variety of materials including but not limited to various forms of rubber, elastic, latex, polymer, plastic, fabric, foam, wood, grommet, or various other synthetic or natural materials that may provide similar functionality. A membrane may be custom molded to fit a given embodiment of the present invention.

In yet another exemplary embodiment of the present invention, it is considered that a fluid 1502 or a fluid 1307 may enter at one end of a movable cylinder 402, while various alternative methods of imparting rotational movement may be attached to the same end or the opposite end of a movable cylinder.

### SUMMARY

In the foregoing specification, the invention has been described with reference to specific exemplary embodiments. Various modifications and changes may be made, however, without departing from the scope of the present invention as set forth in the claims. The specification and figures may be illustrative, rather than restrictive, and modifications may be intended to be included within the scope of the present invention. Accordingly, the scope of the invention should be determined by the claims and their legal equivalents rather than by merely the examples described.

For example, the steps recited in any method or process claims may be executed in any order and may be not limited to the specific order presented in the claims. Additionally, the components and/or elements recited in any apparatus claims may be assembled or otherwise operationally configured in a variety of permutations and may be accordingly not limited to the specific configuration recited in the claims.

Benefits, other advantages and solutions to problems have been described above with regard to particular embodiments; however, any benefit, advantage, solution to a problem or any element that may cause any particular benefit, advantage or solution to occur or to become more pronounced may be not to be construed as critical, required or essential features or components of any or all the claims.

As used herein, the terms “comprise”, “comprises”, “comprising”, “have”, “has”, “having”, “including”, “includes”, “employs”, “employing” or any variation thereof, may be intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

What may be claimed may be:

1. An apparatus for growing a plant comprising a plurality of openings located substantially concentric to a central axis, wherein at least one of said a plurality of openings is capable of receiving at least one plant, such that at least one part of said at least one plant penetrates through one of said openings in an orientation such that the at least one plant, when present, grows substantially away from the a central axis.

2. An apparatus for growing a plant as recited in claim 1, wherein said a plurality of openings are located along the outer surface of a movable cylinder.

3. An apparatus for growing a plant as recited in claim 2, wherein said cylinder is structurally mounted to the a central axis via a rotational connection such that the said cylinder is able to rotate substantially concentric to the a central axis.

4. An apparatus for growing a plant as recited in claim 3, wherein a fluid is allowed to flow along said a central axis.

5. An apparatus for growing a plant as recited in claim 4, wherein said a fluid is directed substantially toward the root structure of the a plant.

6. An apparatus for growing a plant as recited in claim 5, wherein said a fluid is disbursed via at least one nozzle.

7. An apparatus for growing a plant as recited in claim 6, wherein said a central axis is a tube, and wherein said a fluid is allowed to flow inside said a tube, and wherein said at least one nozzle is provided the said a fluid from the said a tube.

8. An apparatus for growing a plant as recited in claim 3, wherein said a plant is anchored to a medium containing basket, and wherein said a medium containing basket is contained substantially within one of said plurality of openings.

9. An apparatus for growing a plant as recited in claim 8, wherein a membrane is arranged between said a medium containing basket and said a plant, so that a substantially water tight seal is achieved between said a medium containing basket and said a plant.

10. An apparatus for growing a plant as recited in claim 9, wherein said a membrane creates a substantially water tight seal between said a medium containing basket and at least one of said a plurality of openings.

11. An apparatus for growing a plant comprising a movable cylinder comprising a plurality of openings located substantially concentric to a central axis, wherein at least one of said a plurality of openings is capable of receiving at least one plant, such that a root structure of the at least one plant is contained substantially within a movable cylinder and wherein the plant mass of the at least one plant substantially grows outside the interior of a movable cylinder.

12. An apparatus for growing a plant as recited in claim 11, wherein said movable cylinder is structurally mounted to the a central axis via a rotational connection such that the said movable cylinder is able to rotate substantially concentric to the a central axis.

13. An apparatus for growing a plant as recited in claim 12, wherein a fluid is allowed to enter said movable cylinder via a plumbing connection, and wherein said a fluid is directed substantially toward the interior of said movable cylinder.

14. An apparatus for growing a plant as recited in claim 13, wherein said a fluid is disbursed via at least one nozzle.

15. A method for growing a plant comprising the steps of: locating at least one part of at least one plant within at least one of a plurality of openings located on a movable cylinder; orienting said at least one plant such that a root structure of the at least one plant is contained substantially within a movable cylinder and wherein the plant mass of the at least one plant substantially grows outside the interior of a movable cylinder.

16. A method for growing a plant as recited in claim 15, wherein a fluid is allowed to flow substantially to the interior of a movable cylinder, and wherein said a root structure of at least one plant is provided at least one of a nutrient which is comprised within said a fluid.

17. A method of growing a plant as recited in claim 16, wherein said a fluid is allowed to drain from a movable cylinder such that said a fluid is substantially collected within a reservoir.

18. A method for growing a plant as recited in claim 17, wherein said root structure of at least one plant is allowed to grow within a medium.

19. A method for growing a plant as recited in claim 18, wherein said medium is substantially contained within a basket.

20. A method of growing a plant as recited in claim 19, wherein a membrane is affixed between said a basket and at least one part of said at least one plant, such that a substantially water tight seal is achieved between said a basket and at least one part of said at least one plant.
